(19) United States
(12) Patent Application Publication
(10) Pub. No.: US 2013/0167973 A1
(43) Pub. Date: Jul. 4, 2013

(54) INK-FILLING MACHINE FOR WRAP-AROUND CORE

(71) Applicant: BEIFA GROUP CO., LTD., Ningbo (CN)

(72) Inventors: Cailiang Dong, Ningbo (CN); Feng Zhu, Ningbo (CN)

(73) Assignee: BEIFA GROUP CO., LTD., Ningbo (CN)

(21) Appl. No.: 13/728,668

(22) Filed: Dec. 27, 2012

(30) Foreign Application Priority Data
Dec. 31, 2011 (CN) 201110459794.4

(51) Int. Cl. B43L 25/00

(52) U.S. Cl. CPC B43L 25/007
USPC 141/18

(57) ABSTRACT

Embodiments of ink-filling devices are described. An ink-filling device may include a feeding-stock arranging track configured to stack workpieces in a single file. An ink-filling needle is configured to move from a first position opposite from the feeding-stock arranging track to a second position within the feeding-stock arranging track. A push rod is configured to move from a first position opposite from the feeding-stock arranging track to a second position within the feeding-stock arranging track. The devices may be used for filling with ink the absorbent wrap-around cores used in writing instruments.

### TECHNICAL FIELD

This disclosure relates to ink-filling devices, and in particular, to an ink-filling device for writing instruments having an absorbent wrap-around core.

### BACKGROUND

Marker pens, felt-tip pens, fiber-tip pens, and other similar writing instruments have become prevalent. Such writing instruments may employ an absorbent core (a wrap-around core) to store ink within the pen. A pen tip fits within the wrap-around core to transfer the ink from the core to the paper when writing. The wrap-around core is required to be filled with ink before use. The conventional method of filling the wrap-around cores includes collecting the wrap-around cores into bundles. An operator holds the bundles and uses an ink-filled syringe to inject ink into each wrap-around core.

The amount of ink injected into each wrap-around core is determined by the operator according to his or her own subjective estimation. Thus, the amount of ink injected into each wrap-around core may be different. A pen having a wrap-around core with insufficient ink will have a shorter life, and a pen having a wrap-around core with excess ink may leak on the paper. The conventional, ink-filling method is very inefficient, leads to quality problems, and is labor intensive. Therefore, it is desired to improve on the method of filling \wrap-around cores with a uniform amount of ink.

### SUMMARY

The disclosed embodiments relate to ink-filling devices. Embodiments of the ink-filling devices may have a simple structure, are convenient to use, and can be reliable. Further, the disclosed ink-filling devices may fill the wrap-around cores with a uniform amount of ink, ensuring proper writing lifespan, and avoiding ink leakage.

At least one embodiment of an ink-filling device includes a feeding-stock arranging track configured to stack workpieces in a single file, an ink-filling needle configured to move from a first position opposite from the feeding-stock arranging track to a second position within the feeding-stock arranging track, and a push rod configured to move from a first position opposite from the feeding-stock arranging track to a second position within the feeding-stock arranging track.

At least one embodiment of an ink-filling device simultaneously activates the ink-filling needle and the push rod to move from the first positions to the second positions.

At least one embodiment of an ink-filling device has the ink-filling needle located above the push rod.

At least one embodiment of an ink-filling device further includes a plurality of workpieces arranged in the feeding-stock arranging track, wherein the workpieces are stacked lengthwise, one longitudinal side on top of another longitudinal side. An end of a first workpiece is positioned opposite from the ink-filling needle in the first position, and an end of a second, ink-filled workpiece is positioned opposite from the push rod in the first position.

At least one embodiment of an ink-filling device further includes a plurality of workpieces arranged in the feeding-stock arranging track, wherein the workpieces are stacked lengthwise, wherein the ink-filling needle in the second position delivers ink to a first workpiece, and in moving the push rod to the second position, the push rod pushes a second, ink-filled, and bottommost workpiece outside of the feeding-stock arranging track.

At least one embodiment of an ink-filling device uses absorbent cores for writing instruments as the first and the second workpieces.

At least one embodiment of an ink-filling device further includes a vibratory bowl feeder having an opening to deliver workpieces to the top of the feeding-stock arranging track, wherein the opening is adjustable to match a length of the workpieces.

At least one embodiment of an ink-filling device further includes a sensor provided at the feeding-stock arranging track to detect a workpiece being fed from the vibratory bowl feeder.

At least one embodiment of an ink-filling device further includes a plunger pump and an ink-injecting cylinder positioned in proximity to one another, wherein a piston rod of the cylinder is connected to a driving shaft of the pump, and the piston rod and driving shaft are parallel.

At least one embodiment of an ink-filling device has the driving shaft of the plunger pump connected with the piston rod of the ink-injecting cylinder via a same connecting plate.

At least one embodiment of an ink-filling device further includes an adjusting block placed opposite to the ink-injecting cylinder, wherein an adjusting nut engaged with the adjusting block is placed directly opposite from an outer end of the piston rod, wherein the distance between the nut and the outer end of the piston rod determines the amount of ink discharged by the plunger pump.

At least one embodiment of an ink-filling device has a feeding-stock arranging track that includes a base plate, a first and second side plate positioned perpendicular to the base plate, and at least one blocking plate, wherein a distance between the first and second side plates is adjustable to match a length of the workpieces. The at least one blocking plate is positioned between the sides plates, and the distance between the at least one blocking plate and the base plate is adjustable to match a width of the workpieces.

At least one embodiment of an ink-filling device has at least one of the first or the second side plates adjustably attached to the base plate, and the at least one blocking plate is adjustably attached to at least one of the first or the second side plates.

At least one embodiment of an ink-filling device has a feeding-stock arranging track that includes at least one first bracket to support a blocking plate to a side plate. The first bracket is adjustable by sliding along a first adjusting groove, and the first bracket is locked in position in the first adjusting groove via a first adjusting knob. The feeding-stock arranging track includes at least one second bracket to support the side plate to the base plate. The second bracket is adjustable by sliding along a second adjusting groove, and the second bracket is locked into position in the second adjusting groove via a second adjusting knob.

At least one embodiment of an ink-filling device has an ink-filling needle that passes through a locating through-hole in the feeding-stock arranging track when moving from the first position to the second position, and the push rod passes between a locating block and a locating groove in the feeding-stock arranging track.

At least one embodiment of an ink-filling device has the ink-filling needle connected with the push rod via a same connecting plate.

At least one embodiment of an ink-filling device includes a vibratory bowl feeder, an ink-injecting cylinder that operates a plunger pump to deliver ink to the ink-injecting needle, a needle-tube cylinder that operates to reciprocate the ink-filling needle, and a controller to start the vibratory bowl feeder, the ink-injecting cylinder, and the needle-tube cylinder.

At least one embodiment of an ink-filling device includes an ink-injecting cylinder that operates a plunger pump to deliver ink to the ink-injecting needle, a needle-tube cylinder that operates to reciprocate the ink-filling needle, and a controller that synchronizes the operation of the ink-injecting cylinder and needle-tube cylinder to cause the plunger pump to deliver ink to the ink-injecting needle at a time when the ink-injecting needle is within the feeding-stock arranging track.

At least one embodiment of an ink-filling device includes a sensor provided at the feeding-stock arranging track, wherein the sensor detects whether a workpiece is delivered to the feeding-stock arranging track. The sensor is connected with a controller and sends a signal when detecting the absence of a workpiece at the feeding-stock arranging track.

At least one embodiment of an ink-filling device includes an ink-filling device having a frame, a feeding mechanism, a feeding-stock arranging track, an ink-injecting mechanism, an ink-filling mechanism, a stock-pushing mechanism, and a controller, which are each arranged on the frame. The feeding mechanism includes of a vibratory bowl feeder and a vibration motor. The ink-injecting mechanism includes a plunger pump, an ink-injecting cylinder, and a first connecting plate. The ink-filling mechanism includes an ink-filling needle, a needle-tube cylinder, a second connecting plate, and a locating through-hole, wherein the locating through-hole is provided at the feeding-stock arranging track, and allows the ink-filling needle to pass. The stock-pushing mechanism includes a push rod and a locating block.

The feeding opening of the vibratory bowl feeder is connected with the upper end of the feeding-stock arranging track. The feeding-stock arranging track communicates with the vibratory bowl feeder via the feeding opening. The lower end of the feeding-stock arranging track is connected with the locating block. The suction inlet of the plunger pump is connected with an ink storage container through a tube. The discharge outlet of the plunger pump is connected with the tail end of the ink-filling needle through a tube. The driving shaft of the plunger pump is connected with the piston rod of the needle-tube cylinder via the first connecting plate. The tail end of the ink-filling needle is connected with the piston rod of the needle-tube cylinder via the second connecting plate. The position of the locating through-hole corresponds to the position of a wrap-around core arranged at the feeding-stock arranging track. The tail end of the push rod is fixed at the second connecting plate. Therefore, the push rod and ink-filling needle operate in unison.

A locating groove at the bottom of the feeding-stock arranging track supports the bottommost, ink-filled wrap-around core. The locating groove allows the push rod to pass into the feeding-stock arranging track. The push rod, when extended, pushes the bottommost, ink-filled wrap-around core out of the locating groove. When the push rod is retracted out of the feeding-stock arranging track, the remaining wrap-around cores, of which at least the bottommost one is filled with ink, fall in unison in the feeding-stock arranging track so that the bottommost, ink-filled wrap-around core occupies the locating groove once again. The cycle of simultaneously filling a wrap-around core with ink and pushing the bottommost, ink-filled wrap-around core is repeated continuously. The controller operates the vibration motor, a solenoid valve of the ink-injecting cylinder, and a solenoid valve of the needle-tube cylinder.

At least one embodiment of an ink-filling device has a detecting sensor provided at the feeding-stock arranging track in order to detect whether the vibratory bowl feeder is feeding wrap-around cores to the feeding-stock arranging track. The detecting sensor is connected with the controller and sends a signal when the sensor detects that the vibratory bowl feeder is not continuing to feed the wrap-around cores to the feeding-stock arranging track. The controller controls the motor of the vibratory bowl feeder, the solenoid valve of the ink-injecting cylinder, and the solenoid valve of the needle-tube cylinder to start and stop according to the signal sent by the detecting sensor.

At least one embodiment of an ink-filling device has an ink-amount adjusting mechanism provided on the frame. The ink-amount adjusting mechanism can include an ink-amount adjusting block and an ink-amount adjusting nut provided on the ink-amount adjusting block. The plane of the top end of the ink-amount adjusting nut is parallel with the plane of the outer end of the piston rod of the ink-injecting cylinder. The axis of the ink-amount adjusting nut is at the same level with the axis of the piston rod of the ink-injecting cylinder, and the distance between the top end of the ink-amount adjusting nut and the outer end of the piston rod of the ink-injecting cylinder determines the amount of ink discharged by the plunger pump.

At least one embodiment of an ink-filling device has a feeding-stock arranging track that includes a base plate, side plates provided at the two sides of the base plate, and blocking plates connected inside the side plates. The distance between the inner sides of the two side plates corresponds to the axial length of the wrap-around core. The distance between the two blocking plates is less than the axial length of the wrap-around core. The distance between the inner side of the base plate and the inner sides of the blocking plates corresponds to the diameter of the wrap-around core.

At least one embodiment of an ink-filling device has a first distance-adjusting mechanism to adjust the distance between the inner side of the base plate and the inner sides of the blocking plates to correspond to the diameter of the wrap-around core. The first distance-adjusting mechanism includes an L-shaped bracket, an adjusting groove, and an adjusting knob cooperating with the adjusting groove. One end of the L-shaped bracket is immovably connected with a blocking plate, the other end thereof is provided with a connecting through-hole. The adjusting groove can be provided at a side plate. The adjusting knob extends through the adjusting groove and the connecting through-hole in order to fasten the L-shaped bracket to the side plate, thusly locking the blocking plate at the correct distance from the base plate.

At least one embodiment of an ink-filling device has a second distance-adjusting mechanism to adjust the distance between the inner sides of the two side plates to correspond to the axial length of the wrap-around cores. The second distance-adjusting mechanism includes an L-shaped bracket, an adjusting groove, and an adjusting knob cooperating with the adjusting groove. One end of the L-shaped bracket is immovably connected with a side plate, the other end thereof is provided with a connecting through-hole. The adjusting knob extends through the adjusting groove and the connecting through-hole in order to fasten the L-shaped bracket to the base plate, thusly locking one side plate at the correct distance from the second side plate. One or more brackets can be provided on each of the side plates or blocking plates.

At least one embodiment of an ink-filling device has a length-adjusting plate provided at the vibratory bowl feeder for adjusting the length of the feeding opening.

At least one embodiment of an ink-filling device has a receiving groove provided on the frame. The receiving groove communicates with the locating groove, and the wrap-around core filled with ink can be pushed out of the locating groove into the receiving groove by the push rod.

The ink-injecting cylinder drives the driving shaft of the plunger pump to reciprocate so that the plunger pump continuously draws ink from the storage container and then discharges the ink to the ink-filling needle. The needle-tube cylinder drives the ink-filling needle and the push rod to reciprocate, and when the needle tip of the ink-filling needle moves into the wrap-around core arranged at the feeding-stock arranging track, the ink within the ink-filling needle fills one of the wrap-around cores. At the same time, the push rod pushes the wrap-around core previously filled with ink out of the locating groove. As the amount of ink drawn by the plunger pump is constant, the amount of ink filled into each wrap-around core is also constant and uniform among the plurality of wrap-around cores. Therefore, the writing lifespan of pens can be ensured and ink leakage can be avoided. Furthermore, efficiency is improved and manual labor is reduced.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 schematically shows the three-dimensional structure of an embodiment of an ink-filling device for wrap-around cores;

FIG. 2 schematically shows the structure of an embodiment of a plunger pump, ink-injecting cylinder, and connecting plate;

FIG. 3 schematically shows the structure of an embodiment of a feeding-stock arranging track, ink-filling needle, push rod, connecting plate, and needle-tube cylinder;

FIG. 4 schematically shows the structure of an embodiment of a feeding-stock arranging track;

FIG. 5 schematically shows a cross-sectional structure of an embodiment of a feeding-stock arranging track;

FIG. 6 schematically shows the structure of an embodiment of a vibratory bowl feeder and feeding-stock arranging track;

FIG. 7 schematically shows the structure of an embodiment of an ink-amount adjusting mechanism;

FIG. 8 schematically shows the structure of an embodiment of a distance-adjusting mechanism;

FIG. 9 schematically shows the structure of an embodiment of a distance-adjusting mechanism; and

FIG. 10 schematically shows the structure of an embodiment of a length-adjusting plate in the vibratory bowl feeder.

### DETAILED DESCRIPTION

Devices for filling workpieces with ink are disclosed herein. Workpieces as used herein can include, but are not limited to, ink-absorbent cores used in writing instruments. An embodiment of an absorbent core is a wrap-around core. The absorbent cores can be made from natural or synthetic fibers. While wrap-around cores are used for describing embodiments of the ink-filling devices, this is done merely for illustration purposes only, and is not intended to limit the use of the ink-filling devices solely for wrap-around cores.

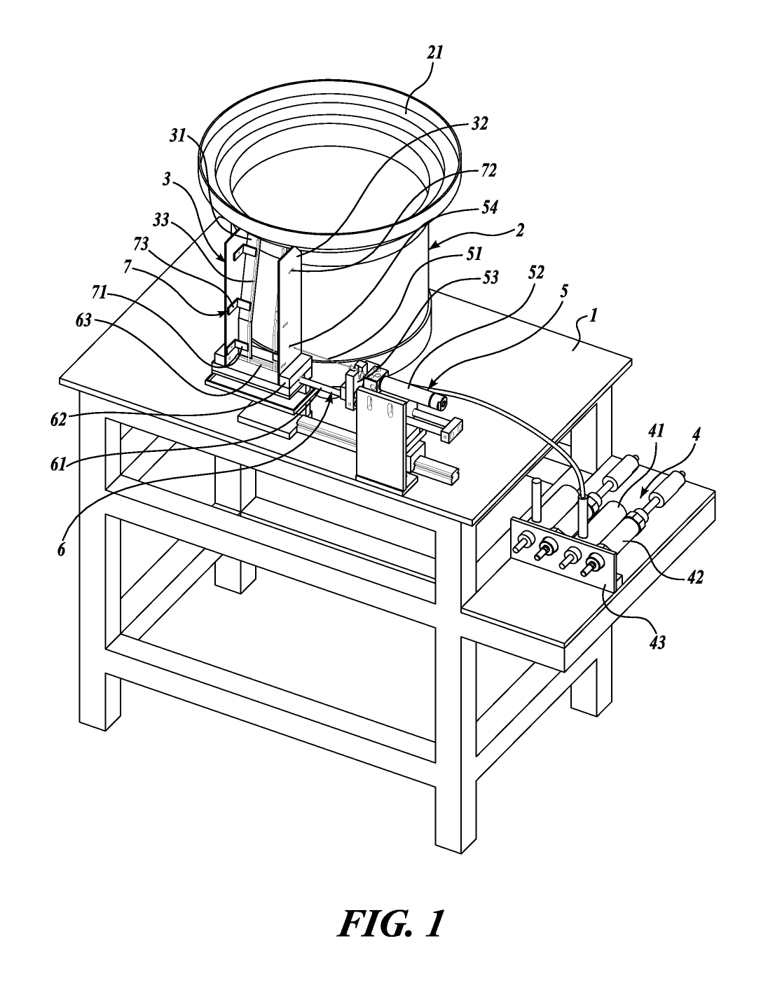

As shown in FIG. 1, one embodiment of an ink-filling device includes a frame 1, a feeding mechanism 2, a feeding-stock arranging track 3, an ink-injecting mechanism 4, an ink-filling mechanism 5, a stock-pushing mechanism 6, and a controller, each of which may be arranged on the frame 1.

The feeding mechanism 2 may include a directional vibratory bowl feeder 21 and a vibration motor connected with the directional vibratory bowl feeder 21. The ink-injecting mechanism 4 may include a plunger pump 41, an ink-injecting cylinder 42, and a first connecting plate 43. The ink-filling mechanism 5 may include an ink-filling needle 51, a needle-tube cylinder 52, a second connecting plate 53, and a locating through-hole 54. The locating through-hole 54 is provided at the feeding-stock arranging track 3 and cooperates with the ink-filling needle 51. The stock-pushing mechanism 6 may include a push rod 61 and a locating block 62.

A feeding opening of the directional vibratory bowl feeder 21 is connected with the upper end of the feeding-stock arranging track 3, such that the feeding-stock arranging track 3 receives empty wrap-around cores from the vibratory bowl feeder 21 via its feeding opening. The lower end of the feeding-stock arranging track 3 connects with a locating block 62. The locating block 62 can guide the push pod 61 into the feeding-stock arranging track 3. The ink suction opening of the plunger pump 41 is connected with an ink storage container via a tube. The ink-discharging opening of the plunger pump 41 is connected with the tail end of the ink-filling needle 51 through a tube.

The driving shaft of the plunger pump 41 is connected with the piston rod of the ink-injecting cylinder 42 via a first connecting plate 43. The tail end of the ink-filling needle 51 is connected with the piston rod of the needle-tube cylinder 52 via the second connecting plate 53. The position of the locating through-hole 54 corresponds to that of one empty wrap-around core arranged at the feeding-stock arranging track 3, and the locating through-hole 54 is aligned with the ink-filling needle 51. The tail end of the push rod 61 is also fixed at the second connecting plate 53. Therefore, the ink-filling needle 51 and the push rod 61 operate in unison and move from a first position outside of the feeding-stock arranging track 3 to a second position inside of the feeding-stock arranging track 3. A locating groove piece 63 below the locating block 62 cooperates with the locating block 62 to guide the push rod 61 within the locating groove 63 to push the bottommost, ink-filled wrap-around core out of the feeding-stock arranging track 3.

When the ink-filling needle 51 and push rod 61 are retracted to the outside of the feeding-stock arranging track 3, a stack of wrap-around cores, of which at least the bottommost wrap-around core is filled with ink, will fall in the feeding-stock arranging track 3. The feeding-stock arranging track 3 is configured to keep the wrap-around cores in a single file stacked one atop the next, such that the longitudinal side of one wrap-around core rests on the longitudinal side of the wrap-around core beneath it. Thus, the wrap-around cores fall incrementally from the top to the bottom in the feeding-stock arranging track each time the lowest, ink-filled wrap-around core is pushed out. The push rod 61 pushes the bottommost, ink-filled wrap-around core in the locating groove 63 out of the locating groove 63 and into a receiving area for further assembling. A controller is provided to control the start and stop of the motor operating the vibratory bowl feeder 21, a solenoid valve of the ink-injecting cylinder 42 and a solenoid valve of the needle-tube cylinder 52. Solenoid valves are activated electrically to create a magnet that drives an armature to open or close a valve. The valve can be used to permit air to operate the piston rod of a cylinder. Alternatively, some cylinders may operate without pressurized air, so that the armature is directly coupled to the piston rod and moves the piston rod upon energizing the solenoid.

When the ink-filling device operates, the ink-injecting cylinder 42 drives the driving shaft of the plunger pump 41 to reciprocate, so that the plunger pump 41 continuously draws ink from the ink storage container and then discharges the ink to the ink-filling needle 51. At the same time, the needle-tube cylinder 52 drives the ink-filling needle 51 and the push rod 61 to reciprocate. Specifically, the discharge of ink from the plunger pump 41 is timed to correspond to the ink-filling needle 51 moving into an empty wrap-around core arranged at the feeding-stock arranging track 3 and substantially parallel to the ink-filling needle 51 so that as the plunger pump 41 discharges ink, the ink travels through the ink-filling needle 51 and fills the wrap-around core. At the same time as the ink-filling needle 51 moves into the wrap-around core, the push rod 61 pushes the bottommost wrap-around core filled with ink in the locating groove 63 out of the locating groove 63. Because the amount of ink drawn by the plunger pump 41 is constant, the amount of ink delivered to each wrap-around core is also constant. Therefore, the lifespan of the writing instrument can be ensured and ink leakage can be avoided. Furthermore, efficiency is improved due to reducing manual operations.

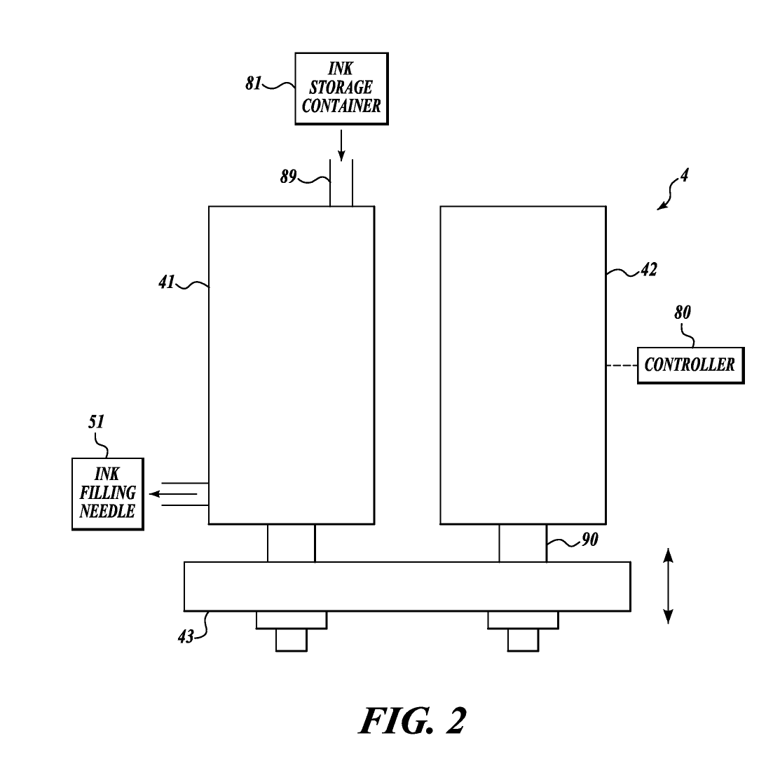

Referring to FIG. 2, a schematic illustration of the ink-injecting cylinder 42 and the plunger pump 41 is provided. One or more pairs of the ink-injecting cylinder 42 and the plunger pump 41 may be provided on the frame 1. The ink injection cylinder 42 may include a solenoid valve that allows air to enter the cylinder and activate the piston rod 90. The ink-injecting cylinder 42 is under command via the controller 80. The controller 80 instructs the ink-injecting cylinder 42 to operate at the same time when the ink-injecting needle 51 enters the feeding-stock arranging track 3. The plunger pump 41 includes an inlet 89 connected to the ink storage container 81. The plunger pump 41 includes an outlet leading to the ink-filling needle 51. The plunger pump 41 may include a driving shaft that can reciprocate to draw ink out of the ink storage container 81 during one stroke, and on the opposite pressure stroke deliver ink to the ink-filling needle 51. A first connecting plate 43 rigidly connects the piston 90 of the ink-injecting cylinder 42 to the driving shaft of plunger pump 41. Therefore, the driving shaft and piston 90 have been arranged to be parallel to each other.

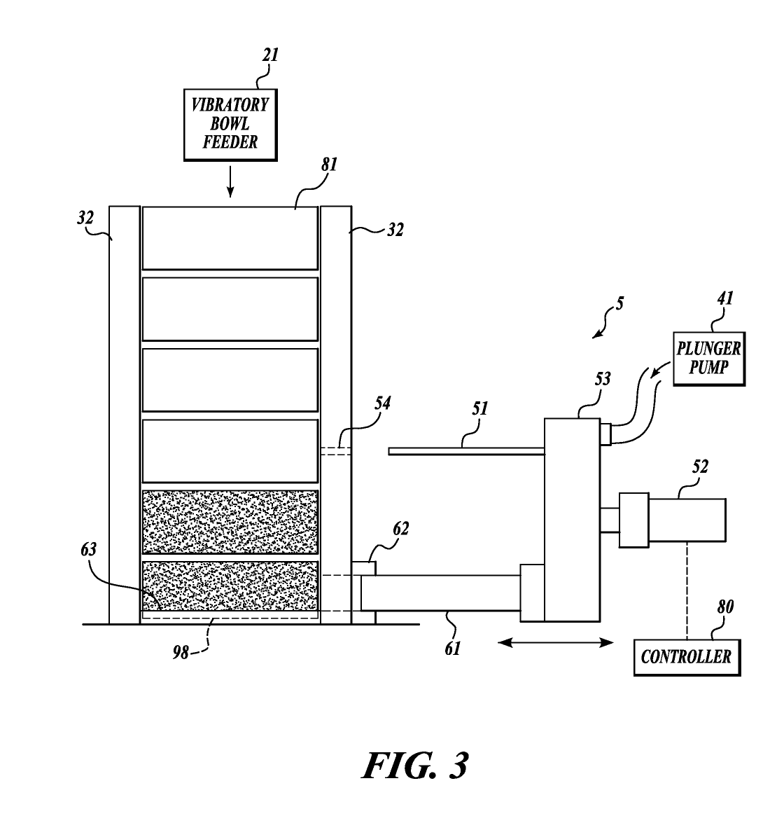

Referring to FIG. 3, a schematic illustration of the feeding-stock arranging track 3, the ink-filling needle 51, push rod 61, second connecting plate 53, and needle-tube cylinder 52 is provided. The needle-tube cylinder 52 may include a solenoid valve that allows air to enter the cylinder to activate a piston rod within the needle-tube cylinder 52. The needle-tube cylinder 52 is caused to activate via the controller 80. The solenoid valve uses electricity to create a magnet that moves an armature in a linear direction to operate a valve that allows pressurized air to enter the cylinder and move the piston rod. The piston of the needle-tube cylinder 52 is connected to the second connecting plate 53. The second connecting plate 53 supports the ink-filling needle 51 and push rod 61, and the ink-filling needle 51 is placed above the push rod 61. Thus, both the ink-filling needle 51 and push rod 61 move together at the same time. The end of the ink-filling needle 51 may pass through the connecting plate 53 to connect with a tube coming from the outlet of the plunger pump 41.

In the position illustrated, both the ink-filling needle 51 and the push rod 61 are retracted in a first position. That is, the ink-filling needle 51 and the push rod 61 are outside of the feeding-stock arranging track 3 and are not engaged with wrap-around cores 81 within the feeding-stock arranging track 3. The feeding-stock arranging track 3 positions the wrap-around cores 81 accurately so that empty wrap-around cores 81 may be filled with ink with the ink-filling needle 51, and at the same time, the bottommost, ink-filled wrap-around core is pushed out of the locating groove 62 by the push rod 61.

For ease in understanding, only the first and second side plates 32 of the feeding-stock arranging track 3 are illustrated in FIG. 3. The distance between the two side plates 32 is adjustable to allow the ink-filling device to accept different sized wrap-around cores 81 for different pens. The construction of the feeding-stock arranging track 3 allows wrap-around cores 81 to neatly stack in a single file, one atop the other with the longitudinal side of a wrap-around core resting on the longitudinal side of the next lowest wrap-around core. The second connecting plate 53 may be vertically adjustable to align at least one of the empty wrap-around cores 81 to be parallel with the ink-filling needle 51 and at least one of the ink-filled wrap-around cores 81 to be parallel to the push rod 61. The vibratory bowl feeder 21 delivers the empty wrap-around cores 81 to the feeding-stock arranging track 3. The side plate 32 includes a locating through-hole 54 therein to allow the ink-filling needle 51 to pass through the side plate 32 and inject ink into an empty wrap-around core 81. Once a wrap-around core 81 has been filled with ink, both the ink-filling needle 51 and the push rod 61 are retracted, and the bottommost wrap-around core filled with ink falls onto the locating groove 63. The locating groove 63 generally includes a semicircular groove so as to hold the bottommost ink-filled wrap-around core. Also, the locating groove 63 allows the bottommost ink-filled wrap-around core 81 to become aligned directly opposite from the end of the push rod 61.

The locating groove piece 63 cooperates with the locating block 62. The locating block 62 is positioned on top of the locating groove piece 63 so as to create a hole through which the push rod 61 may pass. As both the needle-tube cylinder 52 and the ink-injecting cylinder 42 are under control of controller 80, the controller 80 directs the needle-tube cylinder 52 to extend at a time when the ink-injecting cylinder 42 operates the plunger pump 41. This is to time the delivery of ink to the empty wrap-around core when the ink-filling needle 51 enters the feeding-stock arranging track. As can be appreciated, when in the extended position, the ink-filling needle 51 will be inserted in the directly opposite, and empty wrap-around core, and the push rod 62 will push the bottommost, ink-filled wrap-around core out of the feeding-stock arranging track 3. When the piston of the needle-tube cylinder 53 is retracted, the ink-filling needle 51 is removed from the newly-filled wrap-around core, the push rod 61 is retracted leaving an empty location for the bottommost, ink-filled wrap-around core in the stack to drop into the locating groove 63, and the ink-injecting cylinder 42 will operate the plunger pump 41 to be recharged with ink in anticipation of the next cycle.

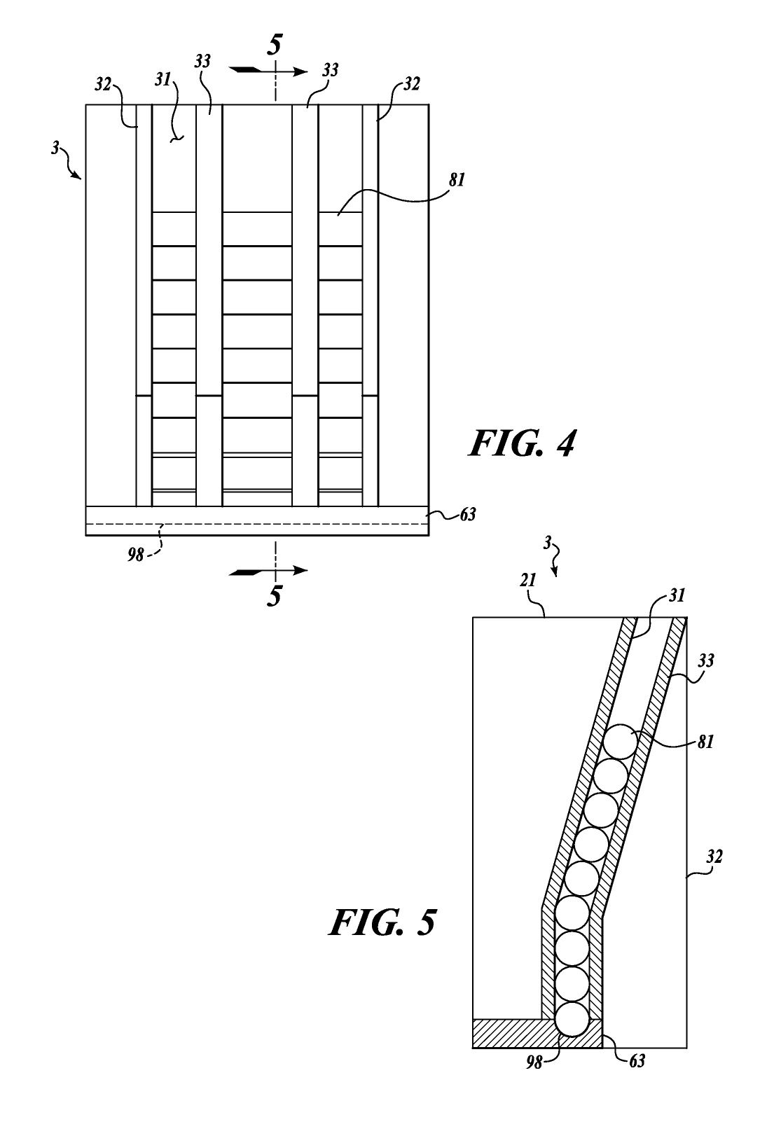

With reference to FIGS. 4 and 5, the feeding-stock arranging track 3 will be described in more detail. The feeding-stock arranging track 3 includes a base plate 31 that can be made from a flattened metal piece. The base plate 31 is vertically positioned next to or juxtaposed against the exterior side of the vibratory bowl feeder 21 below the feeding opening. As shown in FIG. 5, the base plate 31 follows the contour of the exterior side of the vibratory bowl feeder 21.

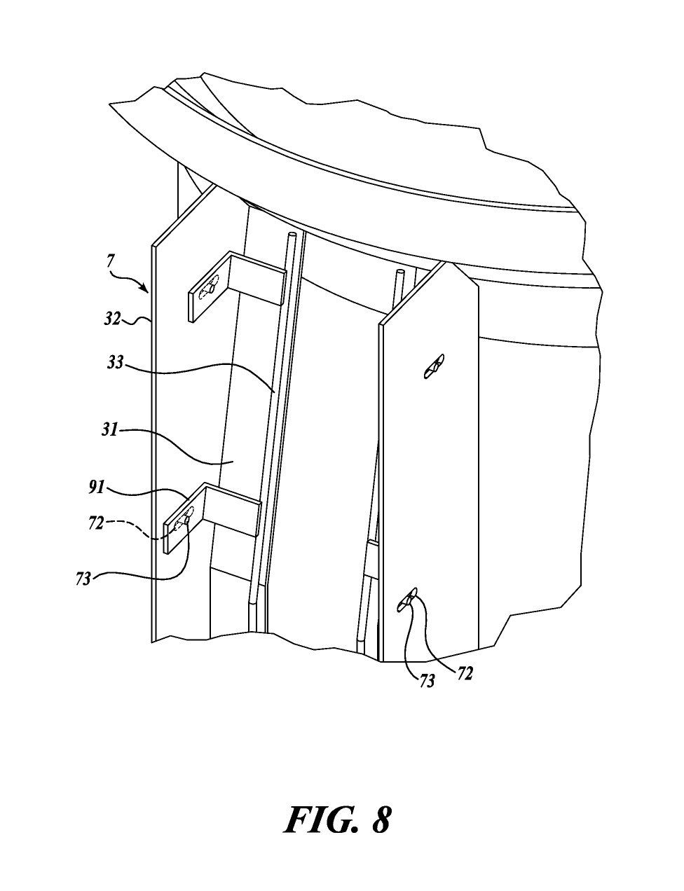

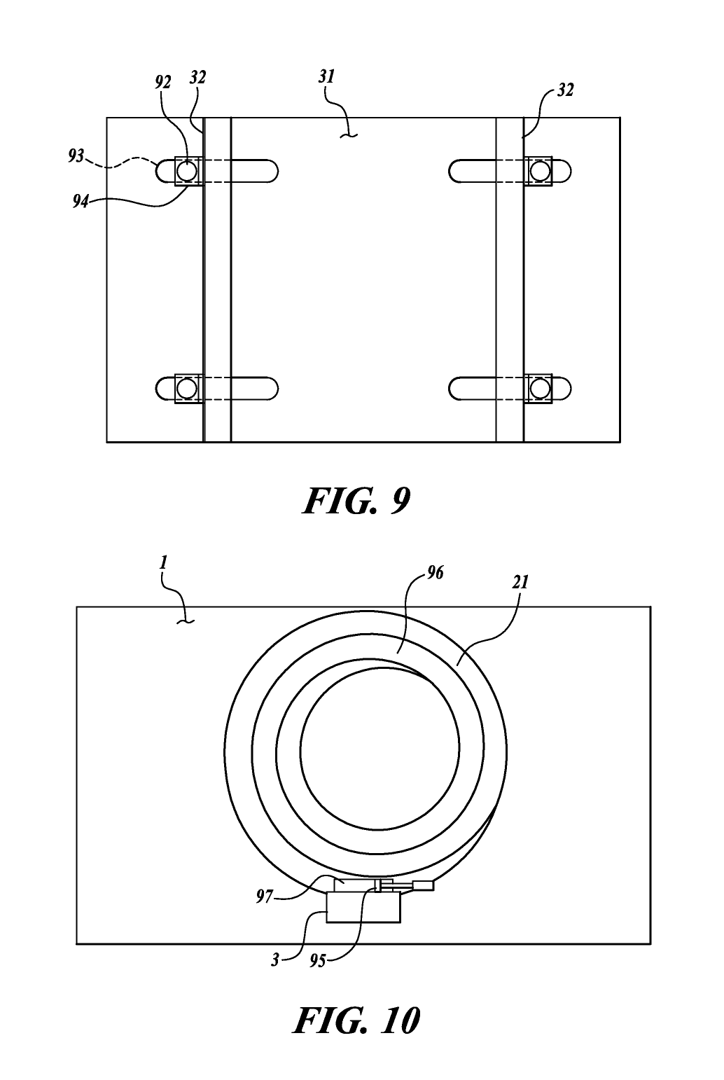

Returning to FIG. 4, the feeding-stock arranging track 3 also includes a first and second side plate 32 provided on opposite sides of the base plate 31. The side plates 32 are flat members positioned generally perpendicular to the base plate 31. The inside dimension between the two side plates 32 is adjustable to slightly exceed the length of the wrap-around cores 81. The adjustment mechanism is described below in connection with FIG. 9. The feeding-stock arranging track 3 may include a first and second blocking plate 33. The blocking plates 33 are positioned vertically between the two side plates 32. The blocking plates 33 may be made from sheet metal members or rods, for example. Referring to FIG. 5, the blocking plates 33 are separated from the base plate 31 corresponding to a distance that slightly exceeds a diameter of the wrap-around cores 81. The adjustment mechanism for adjusting the distance between a blocking plate 33 and the base plate 31 is described below in connection with FIG. 8.

As can be appreciated from the foregoing description, the wrap-around cores 81 can be stacked in a single file in the feeding-stock arranging track 3 with a lengthwise side of one wrap-around core resting on a lengthwise side of the one below. The side plates 32 and blocking plates 33 maintain an orderly downward advancement of the wrap-around cores in unison. The locating groove piece 63 is located at the bottom of the feeding-stock arranging track 3. As seen in FIG. 5, the locating groove piece 63 includes a groove 98 along the length thereof to accommodate the bottommost wrap-around core 81.

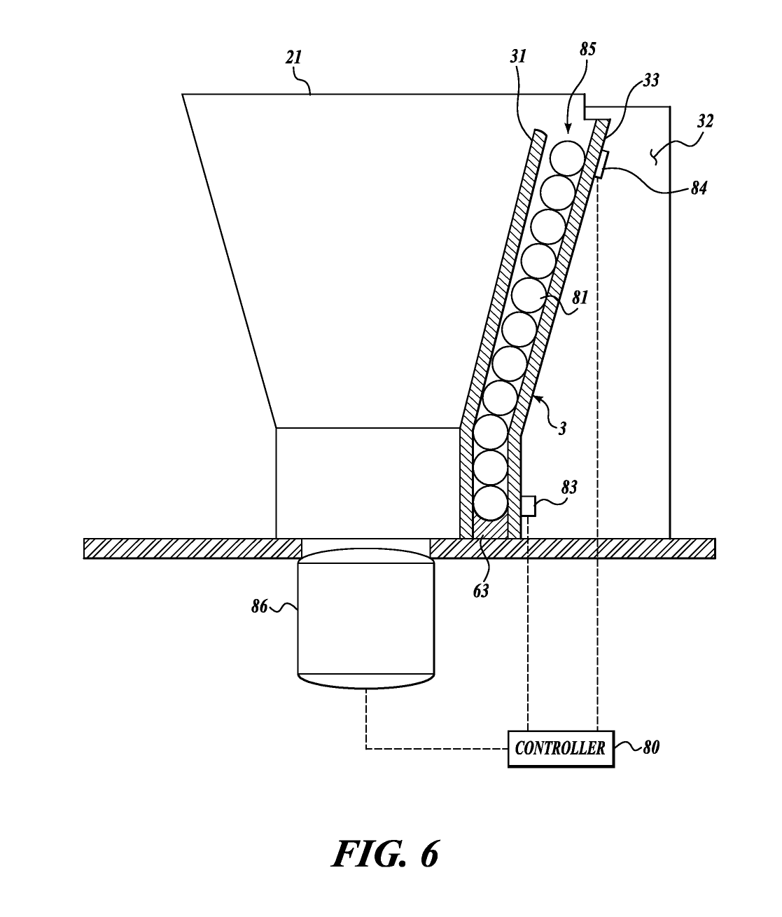

Referring to FIG. 6, additional features of the feeding-stock arranging track 3 and the vibratory bowl feeder 21 are illustrated. The vibratory bowl feeder 21 is connected to a motor 86. The motor 86 in turn is connected to the controller 80 that directs when to turn the motor on and off. The feeding-stock arranging track 3 is placed next to and juxtaposed against the vibratory bowl feeder 21 such that the base plate 31 generally follows the contours of the vibratory bowl feeder 21. The vibratory bowl feeder 21 includes an opening 85 through which the workpieces 81 are fed into the feeding-stock arranging track 3. The feeding-stock arranging track 3 may include a sensing device 84 at the opening 85. The feeding-stock arranging track 3 may also include a sensor 83 at the bottom of the feeding-stock arranging track 3. The sensors 83 and 84 may be photoelectric sensors that can detect the presence or absence of a wrap-around core 81. Alternatively, the sensors 83 and 84 may be switches that may detect the presence or absence of a wrap-around core at the locations corresponding to the sensors. The sensor 83 may detect and count each ink-filled wrap-around core 81 that is pushed out of the locating groove 63 to allow counting the number of ink-filled wrap-around cores that have been produced. The sensor 84 may detect whether the vibratory bowl feeder 21 feeds a wrap-around core to the feeding-stock arranging track. Failure to detect the presence of an ink-filled wrap-around core at the feeding opening may indicate the supply of wrap-around cores in the vibratory bowl feeder 21 has been exhausted or the vibratory bowl feeder 21 has developed a malfunction.

The detecting sensor 84 provided at the feeding-stock arranging track 3 to detect whether the vibratory bowl feeder 21 feeds a wrap-around core 81 to the feeding-stock arranging track 3 is connected with the controller 80. The sensor 84 can send a signal upon detecting that the vibratory bowl feeder 21 fails to feed wrap-around cores to the feeding-stock arranging track 3. The sensor 84 may include a delay time corresponding to the amount of time it takes for the feeding-stock arranging track to be empty of any wrap-around cores. Alternatively, the sensor 84 can also be placed alongside the position corresponding to the ink-filling needle 51. In response to a signal indicating that the vibratory bowl feeder 21 has failed to supply a wrap-around core to the feeding-stock arranging track, the controller 80 can be programmed to stop the vibration motor 86, the solenoid valve of the ink-injecting cylinder 42 and the solenoid valve of the needle-tube cylinder 52. The sensor 84 and controller 80 can ensure that the vibratory bowl feeder 21 operates reliably, and also avoids continuing the ink-filling operation when there is no wrap-around core in the feeding-stock arranging track 3. One or more detecting sensors can be provided at the vibratory bowl feeder opening 85, at the locating groove 63, or at the location of the ink-filling needle 51. Further, the sensor 83 may be used to count the total number of the wrap-around cores that have been filled with ink. The sensor 83 is also connected with the controller 80.

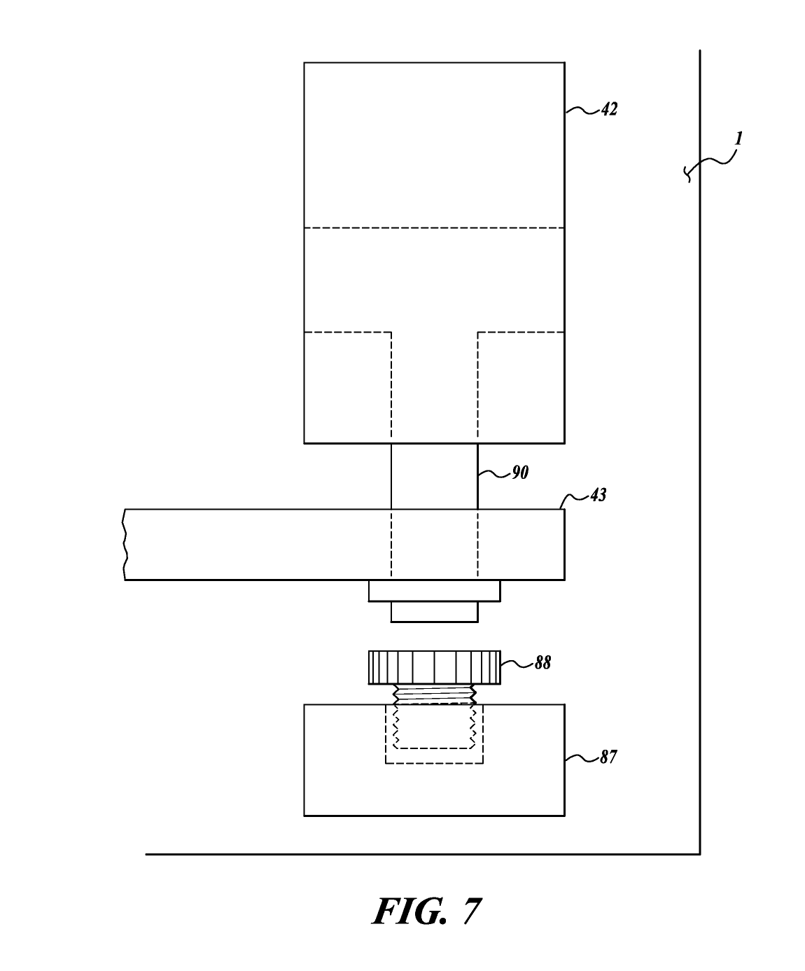

As the wrap-around cores, and workpieces in general, may have different sizes, lengths, and diameters, the ink-filling device is able to adjust to accommodate to the different sizes and the different amounts of ink needed. An ink-amount adjusting mechanism is described in association with FIG. 7, and a first and a second distance-adjusting mechanism is described for the feeding-stock arranging track in association with FIGS. 8 and 9.

Referring to FIG. 7, an ink-amount adjusting mechanism can be provided on the frame 1. The ink-amount adjusting mechanism may include an adjusting block 87 and an adjusting nut 88. The adjusting block 87 is positioned opposite to the piston rod 90 on the ink-injecting cylinder 42. The adjusting block 87 is fixed rigidly to the frame 1. The adjusting nut 88 is mounted within a hole provided in the adjusting block 87. The adjusting nut 88 faces the end of the piston rod 90. Thus, the distance between the adjusting nut 88 and the end of the piston rod 90 determines the length of stroke of the piston 90 and the connecting plate 43. As described above, the connecting plate 43 is connected to the driving shaft on the plunger pump 41. Therefore, the stroke of the plunger pump 41 can be shortened or lengthened by turning the adjusting nut 88 thereby reducing or increasing the amount of ink delivered by the plunger pump 41.

Referring to FIG. 8, a first distance-adjusting mechanism 7 is illustrated. The distance-adjusting mechanism 7 is used to adjust the distance between a blocking plate 33 and the base plate 31. The distance-adjusting mechanism 7 includes an L-bracket 91 that has two members generally perpendicular to each other. One member of the L-bracket 91 may be immovably connected to the blocking plate 33. The other member perpendicular to the first member includes a hole through which an adjusting knob 73 fits.

A slot is formed in the side plate 32, and the adjusting knob 73 passes through the hole and slot 72. The adjusting knob 73 and the L-bracket can move forward and backward within the slot 72. As can be appreciated, by moving the L-bracket within the slot 72, the entire blocking plate 33 can be moved forward or backward, thus increasing or decreasing the distance between the blocking plate 33 and the base plate 31 to match the diameter of the wrap-around cores. A plurality of distance-adjusting mechanisms 7 may be provided for each blocking plate 33.

Referring to FIG. 9, a second distance-adjusting mechanism is illustrated. The second distance-adjusting mechanism is similar in many respects to the first distance-adjusting mechanism 7. However, the second distance-adjusting mechanism is used for adjusting the distance between the two side plates 32. One member of the L-bracket 94 is immovably fixed to the outside surface of the side plate 32. The second perpendicular member of the L-bracket includes a hole through which an adjusting knob 92 fits. The base plate 31 is provided with slots 93. The adjusting knob 92 passes through the hole in the L-bracket and a slot 93. This allows the L-bracket, and thus the immovably connected side plate, to move along the slot 93. The adjusting knob 92 may be tightened to fix the position of the side plate 32 to the base plate 31. Loosening the adjusting knob 92 allows the side plate 32 to move horizontally from side to side the length of the slot 93. Therefore, the distance between the two side plates 32 can be varied. The second distance-adjusting mechanism may be provided for a single side plate or both side plates, and a plurality of distance-adjusting mechanisms may be provided for each side plate.

Referring to FIG. 10, a top view schematic illustration of at least one vibratory bowl feeder 21 is illustrated. A vibratory bowl feeder 21 may include a helical track 96 within the inside of the bowl 21. A vibratory bowl feeder vibrates and causes the wrap-around cores to travel around and upwards in the helical track 96. The helical track ends at an opening 97. As shown in FIG. 10, the opening 97 leads to the feeding-stock arranging track 3. In one embodiment, the opening 97 in the vibratory bowl feeder 21 is adjustable. For example, the length of the opening 97 may be reduced by a plate 95. The plate 95 is connected to an adjusting knob. Turning the knob in one direction may move the plate 95 inwards reducing the length of the opening 97, while turning the knob in the opposition direction moves the plate 95 outwards increasing the length of the opening 97. Thus, the length of the opening 97 may be adjusted by the plate 95.

While illustrative embodiments have been illustrated and described above, it will be appreciated that various changes can be made therein without departing from the spirit and scope of the invention.

The embodiments of the invention in which an exclusive property or privilege is claimed are defined as follows:

1. An ink-filling device, comprising:
a feeding-stock arranging track configured to stack workpieces in a single file;
an ink-filling needle configured to move from a first position opposite from the feeding-stock arranging track to a second position within the feeding-stock arranging track; and
a push rod configured to move from a first position opposite from the feeding-stock arranging track to a second position within the feeding-stock arranging track.

2. The ink-filling device of claim 1, wherein the ink-filling needle and the push rod are activated simultaneously to move from the respective first positions to the respective second positions.

3. The ink-filling device of claim 1, wherein the ink-filling needle is located above the push rod.

4. The ink-filling device of claim 1, further comprising a plurality of workpieces arranged in the feeding-stock arranging track, wherein the workpieces are stacked lengthwise, and an end of a first workpiece is positioned opposite from the ink-filling needle in the first position, and an end of a second workpiece is positioned opposite from the push rod in the first position.

5. The ink-filling device of claim 1, further comprising a plurality of workpieces arranged in the feeding-stock arranging track, wherein the workpieces are stacked lengthwise, wherein the ink-filling needle in the second position delivers ink to a first workpiece, and in moving to the second position, the push rod pushes a second, ink-filled, and bottommost workpiece outside of the feeding-stock arranging track.

6. The ink-filling device of claim 5, wherein the first workpiece and the second workpiece are absorbent cores for writing instruments.

7. The ink-filling device of claim 1, further comprising a vibratory bowl feeder having an opening to deliver workpieces to the top of the feeding-stock arranging track, wherein the opening is adjustable to match a length of the workpieces.

8. The ink-filling device of claim 7, further comprising a sensor provided at the feeding-stock arranging track to detect a workpiece being fed from the vibratory bowl feeder.

9. The ink-filling device of claim 1, further comprising a plunger pump and an ink-injecting cylinder positioned in proximity to one another, wherein a piston rod of the cylinder is connected to a driving shaft of the pump, and wherein the piston rod and driving shaft are parallel.

10. The ink-filling device of claim 9, wherein the driving shaft of the plunger pump is connected with the piston rod of the ink-injecting cylinder via a same connecting plate.

11. The ink-filling device of claim 9, further comprising an adjusting block placed opposite to the ink-injecting cylinder, wherein an adjusting nut engaged with the adjusting block is placed directly opposite from an outer end of the piston rod, and wherein the distance between the nut and the outer end of the piston rod determines the amount of ink discharged by the plunger pump.

12. The ink-filling device of claim 1, wherein the feeding-stock arranging track comprises a base plate, a first and second side plate positioned substantially perpendicular to the base plate, and at least one blocking plate, wherein the distance between the first and second side plates is adjustable to match a length of the workpieces and the at least one blocking plate is positioned between the sides plates, and wherein the distance between the at least one blocking plate and base plate is adjustable to match a width of the workpieces.

13. The ink-filling device of claim 12, wherein at least one of the first or the second side plates is adjustably attached to the base plate, and the at least one blocking plate is adjustably attached to at least one of the first or the second side plates.

14. The ink-filling device of claim 13, wherein the feeding-stock arranging track comprises at least one first bracket to support a blocking plate to a side plate, wherein the first bracket is adjustable by sliding along a first adjusting groove and the first bracket is locked in position in the first adjusting groove via a first adjusting knob, wherein the feeding-stock arranging track comprises at least one second bracket to support a side plate to the base plate, wherein the second bracket is adjustable by sliding along a second adjusting groove and the second bracket is locked into position in the second adjusting groove via a second adjusting knob.

15. The ink-filling device of claim 1, wherein the ink-filling needle passes through a locating through-hole in the feeding-stock arranging track when moving from the first position to the second position, and wherein the push rod passes between a locating block and a locating groove in the feeding-stock arranging track.

16. The ink-filling device of claim 1, wherein the ink-filling needle is connected with the push rod via a same connecting plate.

17. The ink-filling device of claim 1, further comprising a vibratory bowl feeder, an ink-injecting cylinder that operates a plunger pump to deliver ink to the ink-injecting needle, a needle-tube cylinder that operates to reciprocate the ink-filling needle, and a controller to start the vibratory bowl feed, the ink-injecting cylinder, and the needle-tube cylinder.

18. The ink-filling device of claim 1, further comprising an ink-injecting cylinder that operates a plunger pump to deliver ink to the ink-injecting needle, a needle-tube cylinder that operates to reciprocate the ink-filling needle, and a controller that synchronizes the operation of the ink-injecting cylinder and needle-tube cylinder to cause the plunger pump to deliver ink to the ink-injecting needle at a time when the ink-injecting needle is within the feeding-stock arranging track.

19. The ink-filling device of claim 1, further comprising a sensor provided at the feeding-stock arranging track, wherein the sensor detects whether a workpiece is delivered to the feeding-stock arranging track, wherein the sensor is connected with a controller, and the sensor sends a signal when detecting the absence of a workpiece at the feeding-stock arranging track.
